(19) United States
(12) Patent Application Publication
(10) Pub. No.: US 2013/0167053 A1
(43) Pub. Date: Jun. 27, 2013

(54) DISPLAY APPARATUS FOR RELEASING LOCK STATUS AND METHOD THEREOF

(71) Applicants: Ji-yeon KWAK, Seoul (KR); Nipun Kumar, Suwon-si (KR); Jung-joo Sohn, Seoul (KR)

(72) Inventors: Ji-yeon KWAK, Seoul (KR); Nipun Kumar, Suwon-si (KR); Jung-joo Sohn, Seoul (KR)

(73) Assignee: Samsung Electronics Co., Ltd., Gyeonggi-do (KR)

(21) Appl. No.: 13/590,725

(22) Filed: Aug. 21, 2012

(30) Foreign Application Priority Data
Dec. 23, 2011 (KR) 10-2011-0141801

(51) Int. Cl. G06F 3/048

(52) U.S. Cl. 715/764

(57) ABSTRACT

A display apparatus including a display unit for displaying a lock view including an affordance object which represents a changeable natural phenomenon and a control unit for, when the affordance object is touched on the lock view, controlling the display unit to switch to an unlock view while changing the affordance object to display a change of the natural phenomenon in response to the touch.

### PRIORITY

This application claims priority under 35 U.S.C. §119 (a) to Korean Patent Application No. 2011-0141801, which was filed on Dec. 23, 2011 in the Korean Intellectual Property Office, the entire disclosure of which is incorporated herein by reference.

### BACKGROUND OF THE INVENTION

1. Field of the Invention

The present invention relates generally to a display apparatus and a method for releasing a lock status thereof, and more particularly, the present invention relates to a display apparatus for releasing a lock status using an affordance object displayed in a lock view, and a method for releasing the lock status.

2. Description of the Related Art

With the advance of electronic technology, various display devices have been developed and supplied and the use of display devices, such as smart phones, tablets and PCs, supporting various applications is rapidly increasing.

The display devices include a large touch screen so that a user can control operation while viewing content. However, in a device with a large touch screen, the screen of the display device is touched even when the user does not intend to. To prevent such inadvertent input, the display device can support a lock function where even when the screen is touched or a key is selected in the lock state, no function is performed in response. The user can release the lock status with a preset operation. The user touch operation for releasing the lock status is defined by a display device manufacturer. For example, the manufacturer can design to release the lock status only through a predefined touch operation within a fixed area on the screen.

However, when the fixed touch operation is continuously used in a fixed area of the screen, pixels and touch sensors of the corresponding area under the screen are repeatedly used and thus degraded. Also, a user's need for a more dynamic and interesting User Interface (UI) is not met.

Hence, an unlocking method is needed to provide the user with convenience and entertainment without having to use only a fixed area of the screen.

### SUMMARY OF THE INVENTION

Accordingly, the present invention has been made to solve the above-mentioned problems occurring in the prior art, and the present invention provides a display apparatus for allowing a user to easily and intuitively release a lock status using an affordance object, and a method for releasing the lock status.

According to an aspect of the present invention, there is provided a display apparatus which includes a display unit for displaying a lock view including an affordance object which represents a changeable natural phenomenon and a control unit for, when the affordance object is touched on the lock view, controlling the display unit to switch to an unlock view while changing the affordance object to represent a change of the natural phenomenon in response to the touch.

The display apparatus may further include a storage unit for storing information of a plurality of affordance objects. The control unit randomly determines the affordance object in the storage and changes the affordance object every time the lock view is displayed.

The display apparatus may further include a communication unit for receiving a call connection request. When the call connection request is received in the lock view, the control unit may control the display unit to generate and display a plurality of the affordance objects, and control the communication unit to connect the call when a predetermined affordance objects is touched and to reject the call connection when another predetermined affordance objects is touched.

The display apparatus may further include a communication unit for receiving a call connection request. When the call connection request is received in the unlock view, the control unit may control the display unit to generate and display a plurality of the affordance objects, and control the communication unit to connect the call when a predetermined affordance objects is touched and to reject the call connection when another predetermined affordance objects is touched.

The plurality of the affordance objects differ in at least one of a shape, a size, and a color.

The affordance object includes a visual representation of a living object which grows in response to user touch.

The affordance object includes a visual representation of an object predicted to change in the natural phenomenon according to laws of nature in response to user touch.

The change of the natural phenomenon includes one of object separation, growing, blooming, raining and snowing.

According to another aspect of the present invention, there is provided a method for releasing a lock status of a display apparatus, which includes displaying a lock view including an affordance object which represents a changeable natural phenomenon and when the affordance object is touched on the lock view, switching to an unlock view while changing the affordance object to represent change of the natural phenomenon in response to the touch.

The affordance object may be randomly determined every time the lock view is displayed.

The method may further include receiving a call connection request; generating and displaying a plurality of the affordance objects; and connecting the call when a predetermined affordance object is touched and rejecting the call connection when another predetermined of the affordance object is touched.

plurality of the affordance objects differ in at least one of a shape, a size, and a color..

The affordance object includes a visual representation of a living object which grows in response to user touch.

The affordance object includes a visual representation of an object predicted to change in the natural phenomenon according to laws of nature in response to user touch.

The change of the natural phenomenon includes one of object separation, growing, blooming, raining and snowing.

As set forth above, the user can easily release the lock using the affordance object. Hence, the concentrated use of a particular part of the screen is prevented and the user's satisfaction is increased.

### BRIEF DESCRIPTION OF THE DRAWINGS

The above and other features, aspects and advantages of the invention will be more apparent from the following detailed description taken in conjunction with the accompanying drawings, in which:

FIG. 1 is a block diagram of a display apparatus, according to an embodiment of the present invention;

FIGS. 2 through 5 are diagrams of various unlocking methods in the display apparatus, according to an embodiment of the present invention

FIG. 6 is a block diagram of a display apparatus, according to an embodiment of the present invention;

FIG. 7 is a diagram of display change of an affordance object when a call connection request is received, according to an embodiment of the present invention;

FIGS. 8 through 12 are diagrams of various user operations, according to an embodiment of the present invention;

FIG. 13 is a flowchart of an unlocking method, according to an embodiment of the present invention; and

FIG. 14 is a flowchart of an unlocking method, according to an embodiment of the present invention.

### DETAILED DESCRIPTION OF EMBODIMENTS OF THE PRESENT INVENTION

Hereinafter, the present invention is described in detail with reference to the accompanying drawings, in which aspects of the present invention are illustrated. In the following description, like reference numerals refer to the like elements throughout the drawings. Well-known functions or constructions may be omitted to avoid obscuring the description with unnecessary detail.

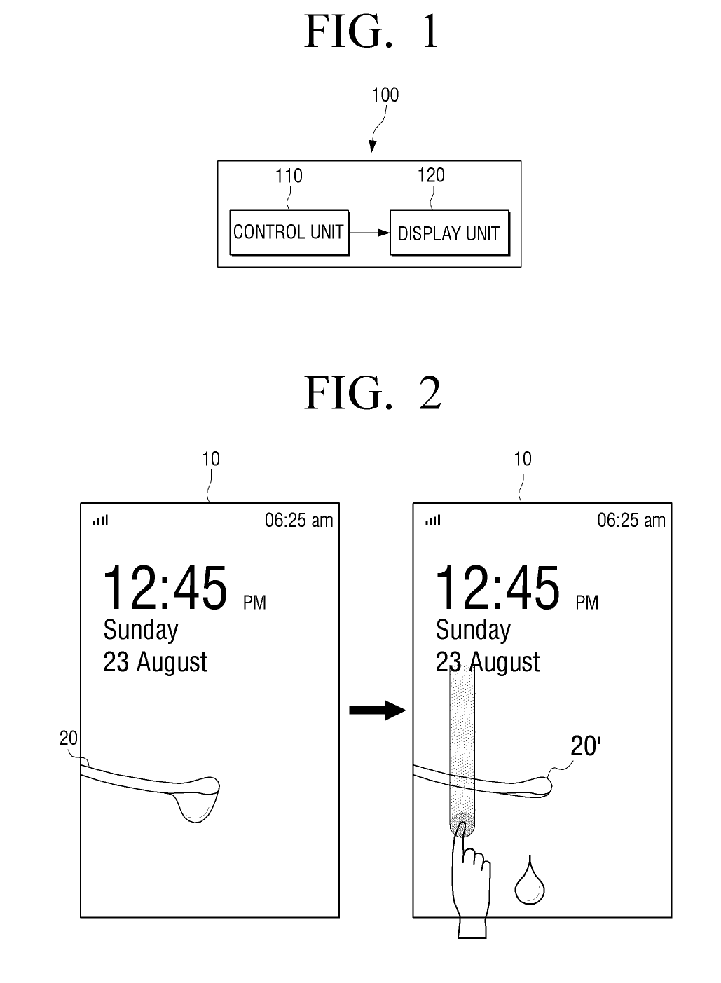

FIG. 1 is a block diagram of a display apparatus according to an embodiment of the present invention. Referring to FIG. 1, the display apparatus 100 includes a control unit 110 and a display unit 120.

The control unit 110 controls operations of the display apparatus 100. The control unit 110 can control hardware of the display apparatus 100 by executing an Operating System (OS) or various applications stored to a memory of the display apparatus 100, and support various functions.

When the display apparatus 100 is turned on or reset, when the ongoing function of the display apparatus 100 is completed, or when there is no user operation or operation of the display apparatus 100 during a certain time, the control unit 110 operates in a lock status. When an event such as user screen touch or button selection in the display apparatus 100 occurs in the lock status, the control unit 110 controls the display unit 120 to display a lock view.

The display unit 120 displays the lock view which includes an affordance object. The affordance object indicates an object generated to guide the user's operation. The affordance object is an object representing a natural phenomenon which is changed by a physical contact of the user. The natural phenomenon indicates a natural event generated according to the laws of nature, such as object separation, growing, blooming, raining and snowing.

When the affordance object is touched in the lock view, the control unit 110 controls the display unit 120 to switch to an unlock view while changing the affordance object to represent the change of the natural phenomenon in response to the touch.

FIG. 2 illustrates an affordance object, according to an embodiment of the present invention. Referring to FIG. 2, the affordance object 20 displayed in the lock view 10 includes a twig and a dewdrop on the twig.

When sensing that the user touches the twig or the dewdrop, the control unit 110 can control the display unit 120 to switch to the unlock view while changing the affordance object 20 to represent the natural phenomenon of the dewdrop detaching from the twig and falling to the ground.

The representation degree of the natural phenomenon can vary depending on a touch level or a touch time. For example, when the user touches the twig firmly, the dewdrop can rapidly drop from the twig. When the user touches the twig softly, the dewdrop can slowly drop from the twig. When the user touches the screen with a pressure below a threshold, the affordance object is generated to represent that the dewdrop is about to drop from the twig, to guide the user to apply more pressure to the touch.

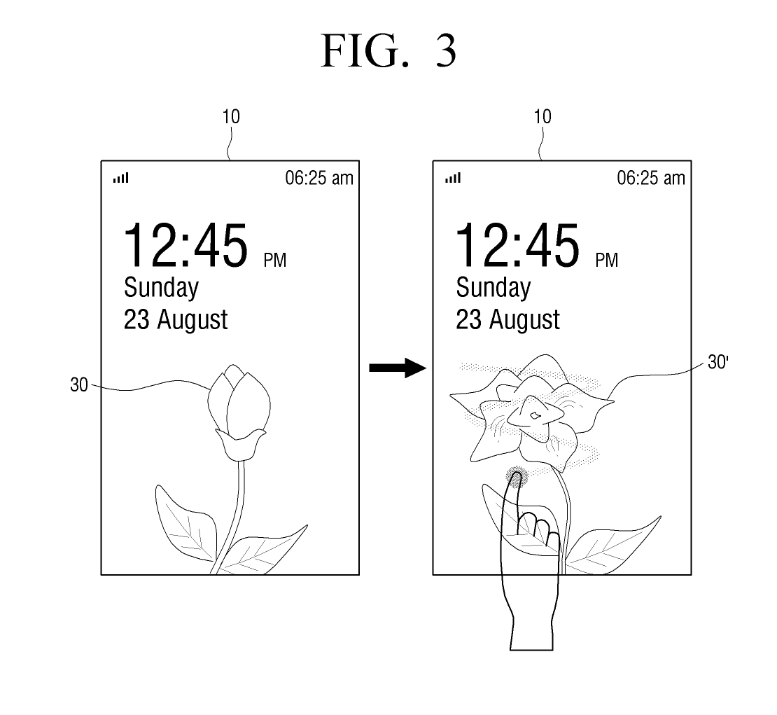

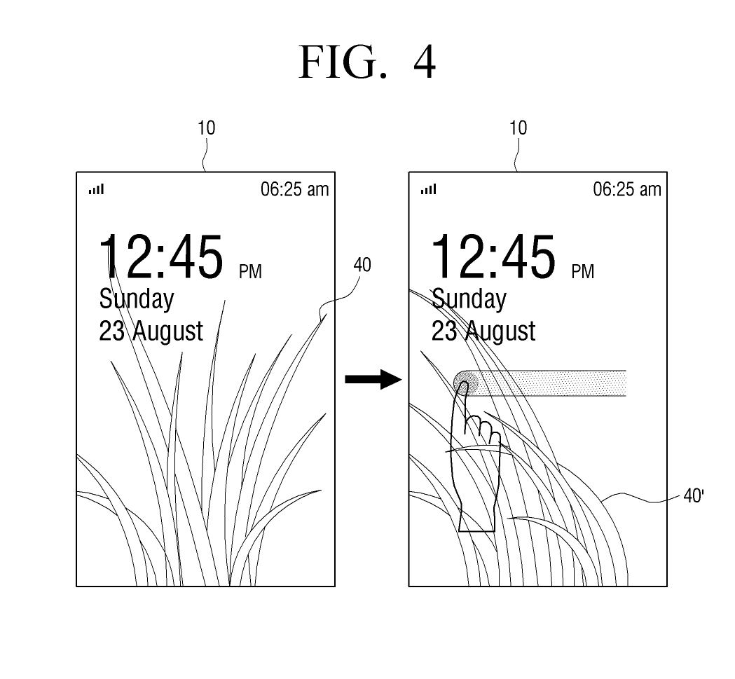

FIG. 3 illustrates another affordance object, according to an embodiment of the present invention. In FIG. 3, the affordance object 30 displayed in the lock view 10 is a living object such as a flower and the flower type is randomly determined. In the lock status, the affordance object 30 is a closed flower bud. When the user rubs the flower bud 30, the affordance object is changed into a blooming flower 30′. The affordance object is not limited to a flower, and may be represented by plants such as grass or trees, people, or animals. For example, a puppy or a child is displayed in the lock status and grow in response to the user's touch to switch to the unlock view.

Further to the affordance objects illustrated in FIGS. 2 and 3, the lock view 10 can display basic information such as time, date, and weather. The basic information is displayed at a location on the lock view 10 that does not overlap with the affordance object.

FIG. 4 illustrates yet another affordance object, according to an embodiment of the present invention. In FIG. 4, the lock view 10 illustrates the affordance object 40 as grass or weeds. When the wind blows in response to the user touch, the affordance object 40′ such as grass or reeds waves in the wind. The control unit 110 controls the display unit 120 to switch to the unlock view while changing the affordance object 40 to represent this natural phenomenon.

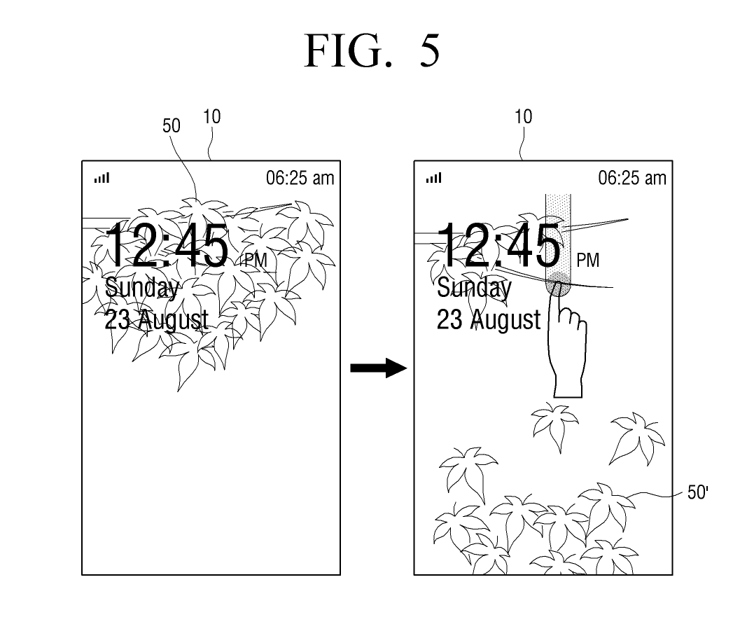

FIG. 5 illustrates yet another affordance object, according to an embodiment of the present invention. In FIG. 5, the affordance object 50 on the lock view 10 is represented by branches with leaves. When the user touches the branch, the natural phenomenon of leaves falling from the branches in response to the touch in the affordance object 50′ is represented. The control unit 110 controls the display unit 120 to switch to the unlock view while changing the affordance object 50 to represent this natural phenomenon.

In FIGS. 3, 4 and 5, the change of the affordance object can vary depending on the touch level or the touch time of the user.

As discussed above, the affordance object is implemented in various forms. Because the affordance objects represent a change of a natural phenomenon the user can intuitively predict based on the laws of nature, the operation of the affordance object, and the change is expressed with a number of other images. For example, when a user rubs a cloud, it can cause rain or snow. When the user rubs the ground, grass can sprout.

The unlock view displayed after the affordance object is changed can vary. For example, the unlock view is an execution view generated according to the execution of a particular application. That is, in the unlock mode, the execution view of an application used before the display apparatus enters the lock status, a default application, or an application frequently used is displayed immediately.

For example, the unlock view may include an icon display region which arranges applications installed to the display apparatus, widgets, folder icons, and menus, and a fixed menu region. The fixed menu region displays functions frequently used by the user, such as call, message, Internet, recent call list, or menus such as default functions.

The unlock view is automatically displayed after the affordance object is changed to represent the change of the natural phenomenon.

As stated above, the affordance object includes a variety of objects of which the change of the natural phenomenon is predicted according to the laws of nature in response to physical user contact. Hence, the affordance object itself can guide user touch and a text or an indicator image instructing to touch the affordance object may also be displayed on the side of the affordance object so that the user can better understand that the affordance object needs to be touched to unlock. Alternatively, the affordance object may regularly wave or flicker so that the user can intuitively recognize the touch.

The display apparatus is implemented using various devices including a Television (TV), a Personal Computer (PC), a tablet PC, a notebook PC, a digital frame, an e-book, a Personal Digital Assistant (PDA), and a mobile phone. A display apparatus having communication capability, such as a mobile phone, can receive a call in the lock status. In this case, the affordance object is changed to determine whether to receive or reject the call in the lock view.

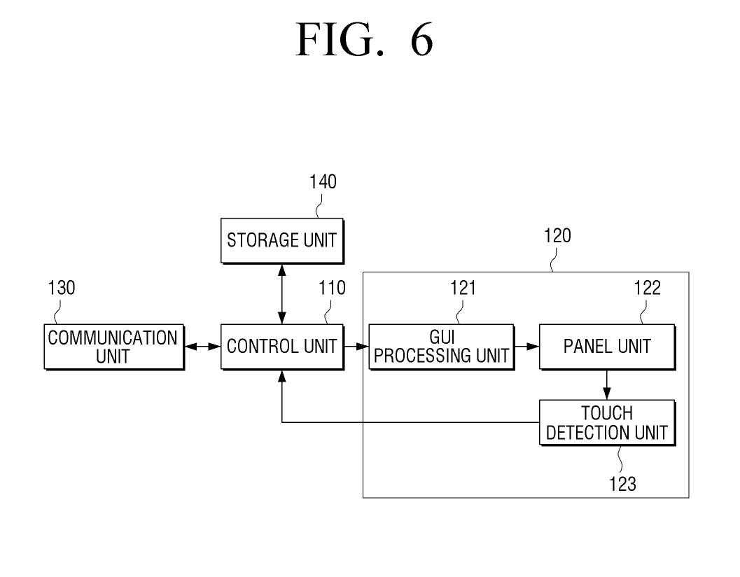

FIG. 6 is a block diagram of a display apparatus according to an embodiment of the present invention. Referring to FIG. 6, the display apparatus includes a control unit 110, a display unit 120, a communication unit 130, and a storage unit 140.

The display unit 120 includes a Graphical User Interface (GUI) processing unit 121, a panel unit 122, and a touch detection unit 123. Using setup information stored in the storage unit 140, the GUI processing unit 121 generates screen configuration data of various types such as lock view, unlock view, and application execution view. Based on the screen configuration data generated by the GUI processing unit 121, the panel unit 122 displays the view by driving hardware including a Liquid Crystal Display (LCD) display panel and a backlight unit. The touch detection unit 123 provides coordinates of the user touch point, to the control unit 110, using a touch sensor equipped in the panel unit 122.

The control unit 110 controls the GUI processing unit 121 and the panel unit 122 to output the view corresponding to the current status of the display apparatus. Using the coordinates provided from the touch detection unit 123, the control unit 110 calculates the user touch point, a touch trajectory, and a motion speed. Based on the calculation result, the control unit 110 determines whether to change the affordance object.

The storage unit 140 stores the OS, applications, widget programs, and data. Specifically, the storage unit 140 can store information relating to the various affordance objects.

The control unit 110 is driven by the OS stored to the storage unit 140 to execute various applications or widget programs selected by the user and to carry out the function. When it is necessary to switch to the lock status, the control unit 110 enters the lock status so that the display apparatus does not respond to any key input or touch of the user. When the user arbitrarily operates the key or touches the screen in the lock status, the control unit 110 controls the display unit 120 to generate and display the lock view.

The communication unit 130 receives a call connection request over a telephone network. When the call is connected, the communication unit 130 converts the user voice input to a voice signal, transmits the voice signal to the other telephone over the telephone network, converts a voice signal received from the other telephone to a voice signal, and provides the voice signal to a speaker.

When the affordance object is touched in the lock view, the control unit 110 controls the display unit 120 to change the affordance object to represent the natural phenomenon change corresponding to the touch and to display the unlock view. When the storage unit 140 stores various affordance objects, the control unit 110 may randomly determine the affordance object displayed in the lock view. Accordingly, the affordance object displayed in the lock view can vary frequently.

In the lock status with the lock view displayed, when the call connection request is received through the communication unit 130, the control unit 110 can change the form or number of the affordance objects so that the user can select whether to connect or reject the call.

When the call connection request is received through the communication unit 130 in the unlock status, the control unit 110 can control the display unit 120 to display the affordance object so that the user can select whether to connect or reject the call as well.

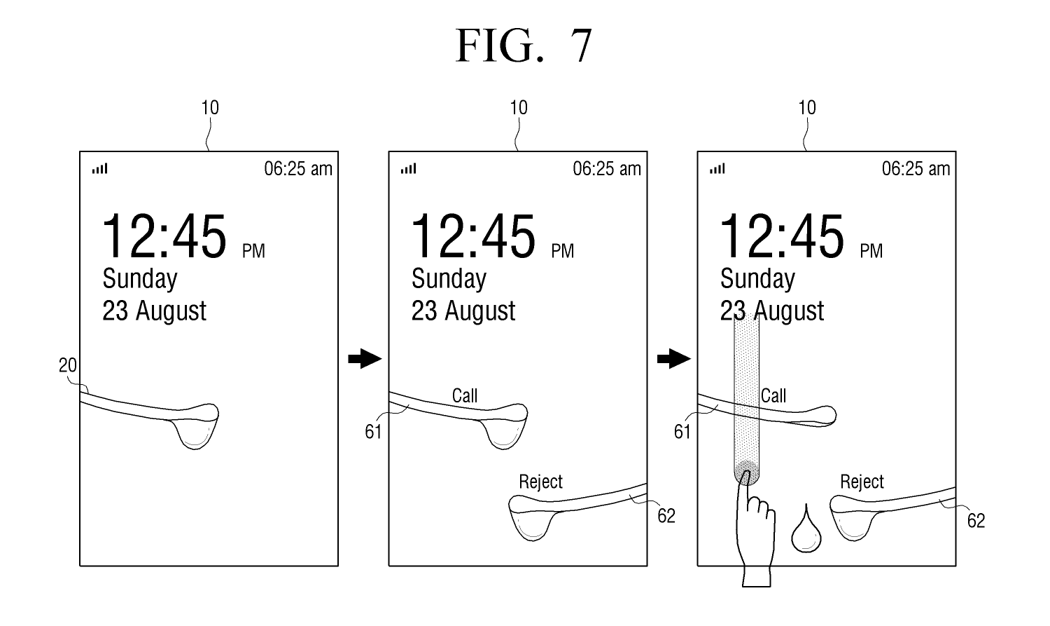

FIG. 7 illustrates the change of the lock view when the call connection request is received. Referring to FIG. 7, when the call connection request is received while the lock view 10 including the affordance object 20 illustrated in FIG. 2 is displayed, affordance objects 61 and 62 are displayed in the lock view 10. One affordance object 61 is mapped to a call connection function, and the other affordance object 62 is mapped to a call rejection function. The user can execute the intended function by touching one of the two affordance objects 61 and 62. In FIG. 7, the first affordance object 61 is touched to connect the call. When the call is connected, the lock view 10 can change to a call connection view.

Although not illustrated in FIG. 7, when the call connection request is received, a part of the lock view 10 may display information such as caller's image, name, or phone number. The affordance object may be changed to a different affordance object. That is, after the affordance object illustrated in FIG. 2 is displayed, the plurality of the objects illustrated in FIG. 3, 4 or 5 may be displayed or different affordance objects based on the function may be displayed. That is, the affordance object illustrated in FIG. 2 is mapped to the call connection function, and the affordance object illustrated in FIG. 3 is mapped to the call rejection function.

The call connection request can also be received in the unlock status. In this case, the control unit 110 can control the display unit 120 to display the plurality of the affordance objects as stated above, map each affordance object to the call connection function or the call rejection function, and perform the corresponding function according to the touch.

Further, there are various operation modes in addition to the received call connection request, for example, a mode for checking a received e-mail or text message, a power-save mode due to a lack of the remaining battery power, and a mode for outputting an alarm signal when a set alarm time arrives. The control unit 110 can enter various operation modes such as mail check mode, power-saving mode, and alarm output mode.

In such operation modes, the control unit 110 can control the display unit 120 to display a plurality of affordance objects mapped to new functions selectable in the corresponding operation mode. For example, the display unit 120 may display an affordance object mapped to a function for checking a received e-mail or text message, together with an affordance object mapped to a function for checking caller information or postponing the text message or mail check.

When the set alarm time arrives and the alarm output mode for outputting the alarm signal is transited, the control unit 110 may display a plurality of affordance objects mapped to various functions, such as an affordance object mapped to an alarm stop function and an affordance object mapped to a function for snoozing the alarm for 5 minutes.

Further, in the power-save mode, the control unit 110 may display a plurality of affordance objects mapped to a function for returning to normal mode and a function for maintaining the power-save mode. As such, the function of the affordance object can vary according to the situation. The plurality of the affordance objects is represented along with text for explaining their mapped function.

Additionally, the affordance objects may differ in at least one of shape, size, and color and functions may be mapped to the plurality of the affordance objects with a single affordance object being represented.

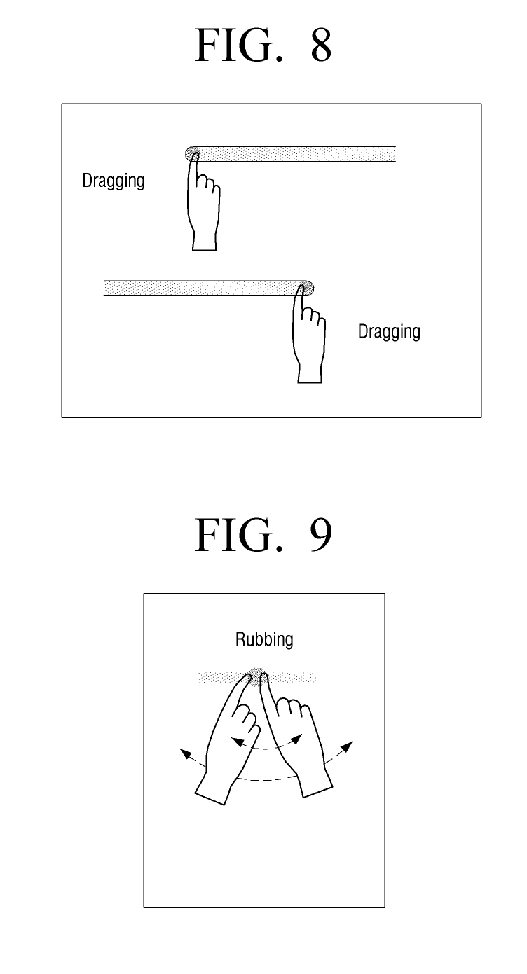

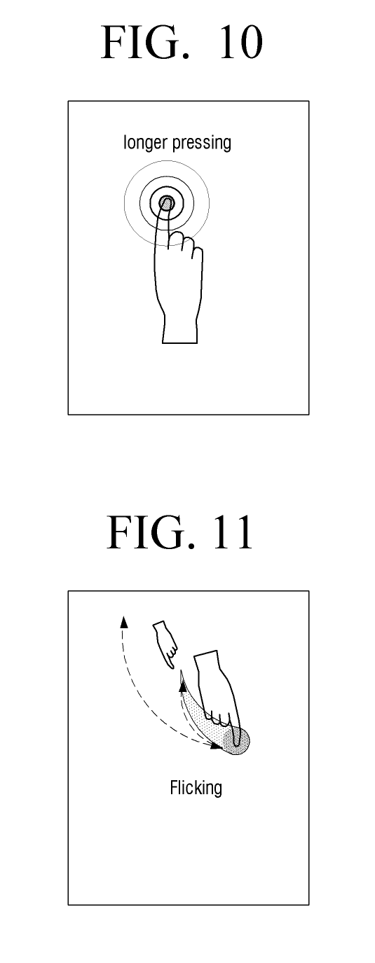

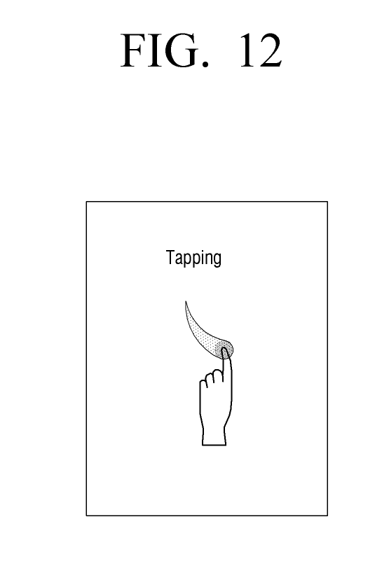

FIGS. 8 through 12 illustrate various user touch operations, according to an embodiment of the present invention. FIG. 8 illustrates a user dragging operation. The drag is the operation which touches a point and moves to another point while still maintaining a touch contact. FIG. 9 illustrates a user rubbing operation. The rubbing operation is the operation which touches a point and moves forward and backward. FIG. 10 illustrates a long pressing operation which presses a point over a threshold time. FIG. 11 illustrates a flicking operation which touches a point and suddenly moves to one direction, and FIG. 12 illustrates a tapping operation of softly touching with a fingertip. As such, the user can change the affordance object by touching the screen in various manners.

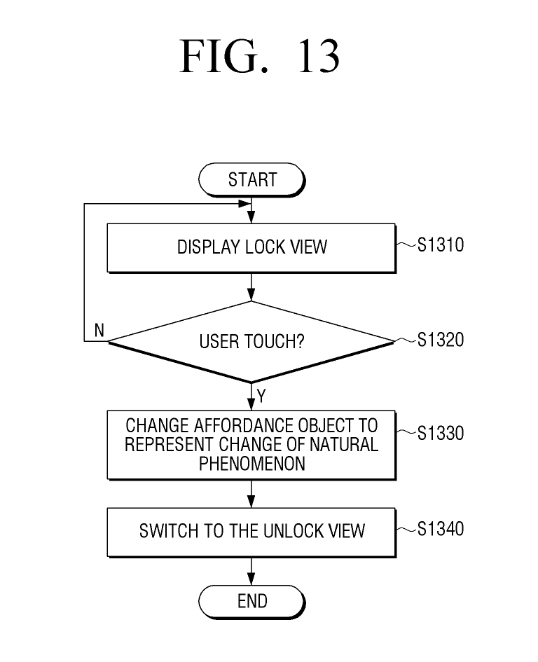

FIG. 13 is a flowchart of an unlocking method according to an embodiment of the present invention. Referring to FIG. 13, the display apparatus displays the lock view including the affordance object in the lock status in Step 1310. The affordance object indicates the object which represents the change of the natural phenomenon in response to the user's physical contact. Specifically, the affordance object is generated in various forms as illustrated in FIGS. 2 through 5.

The user can touch the affordance object on the screen using a finger or a touch pen in Step 1320. In response to the touch, the affordance object is changed to represent the change of the natural phenomenon corresponding to the touch in Step 1330. Herein, the change of the natural phenomenon indicates various phenomena such as object separation, growing, blooming, raining and snowing as mentioned earlier.

As the affordance object is changed in Step 1330, the unlock view is displayed in Step 1340. The unlock view is implemented in various forms as aforementioned.

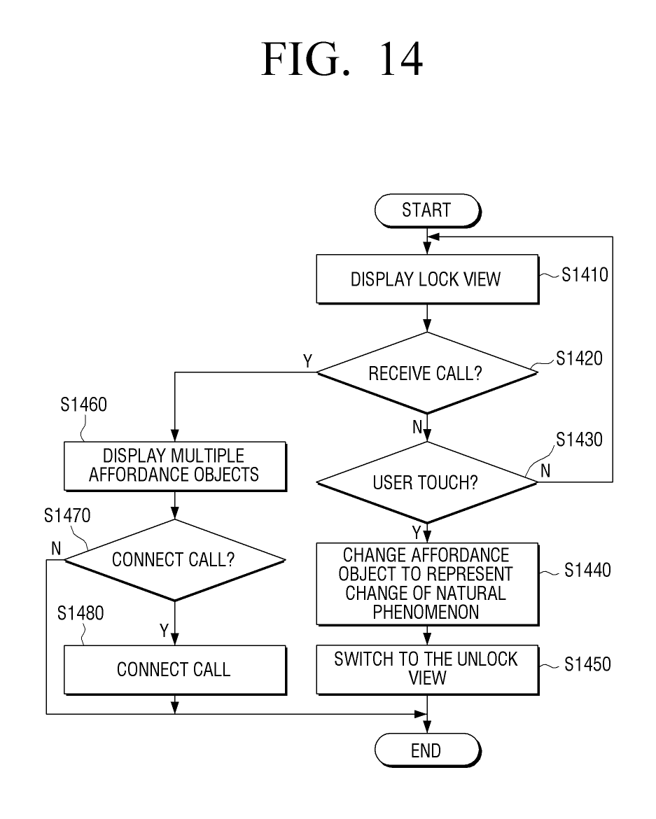

FIG. 14 is a flowchart of an unlocking method according to an embodiment of the present invention. Referring to FIG. 14, when the lock view is displayed in Step 1410 and the call is received in Step 1420, the plurality of the affordance objects is displayed in the lock view in Step 1460. Each affordance object is mapped to a function. For example, the affordance object mapped to the call connection function and the affordance object mapped to the call rejection function is displayed together as illustrated in FIG. 7. The user can determine whether to connect the call by touching the affordance object mapped to the call connection function or to reject the call by touching the affordance object mapped to the call rejection function in Step 1470. When the affordance object mapped to the call connection function is touched, the call is connected in Step 1480 and the call connection view is displayed. When the other affordance object is touched, the call connection is rejected.

When the call is not received in Step 1420 and the user touches the affordance object in Step 1430, the display apparatus changes the affordance object to represent a change in the natural phenomenon according to the touch in Step 1440 and switches to the unlock view by releasing the lock status in Step 1450.

While the plurality of the affordance objects is displayed when the call is received in FIG. 14, various operation modes in addition to the call reception mode is provided. Every time the display apparatus enters each operation mode, it can further display at least one affordance object mapped to the function of the corresponding operation mode.

When the call is received or the operation mode is changed during non-lock status, at least one affordance object mapped to the function is displayed.

The affordance object, displayed in the lock view and the affordance object displayed when the call is received or when the operation mode is switched, is implemented in the same or a different form.

Because the user releases the lock by touching a certain part of the affordance object, and the affordance object randomly varies, there is no fixed area for releasing the lock. Thus, the screen is evenly utilized when releasing the lock, which reduces the partial degradation of the touch panel. Further, the user can find it entertaining to release the lock in various ways which maximizes user satisfaction.

A program for executing the unlock methods according to various embodiments of the present invention is separately provided and recorded to a recording medium. An apparatus implemented with the recording medium can perform the unlock methods by executing the corresponding program.

The program for executing the unlock methods is stored in various recording media readable by the terminal, such as Random Access Memory (RAM), flash memory, Read Only Memory (ROM), Erasable Programmable ROM (EPROM), Electronically Erasable and Programmable ROM (EEPROM), register, hard disc, removable disc, memory card, USB memory, and CD-ROM.

While the present invention has been shown and described, with reference to various embodiments thereof, various changes in form and detail may be made without departing from the scope and spirit of the present invention, defined by the appended claims and their equivalents.

What is claimed is:

1. A display apparatus comprising:
a display unit for displaying a lock view including an affordance object which represents a changeable natural phenomenon; and
a control unit for, when the affordance object is touched on the lock view, controlling the display unit to switch to an unlock view while changing the affordance object to represent a change of the natural phenomenon in response to the touch.

2. The display apparatus of claim 1, further comprising:
a storage unit for storing information of a plurality of affordance objects,
wherein the control unit randomly determines the affordance object in the storage and changes the affordance object every time the lock view is displayed.

3. The display apparatus of claim 1, further comprising:
a communication unit for receiving a call connection request,
wherein, when the call connection request is received in the lock view, the control unit controls the display unit to generate and display a plurality of the affordance objects, and controls the communication unit to connect the call when a predetermined affordance object is touched and to reject the call connection when another predetermined affordance object is touched.

4. The display apparatus of claim 1, further comprising:
a communication unit for receiving a call connection request,
wherein, when the call connection request is received in the unlock view, the control unit controls the display unit to generate and display a plurality of the affordance objects, and controls the communication unit to connect the call when a predetermined affordance object is touched and to reject the call connection when another predetermined affordance object is touched.

5. The display apparatus of claim 3, wherein the plurality of the affordance objects differ in at least one of a shape, a size, and a color.

6. The display apparatus of claim 4, wherein the plurality of the affordance objects differ in at least one of a shape, a size, and a color.

7. The display apparatus of claim 1, wherein the affordance object includes a visual representation of a living object which grows in response to user touch.

8. The display apparatus of claim 1, wherein the affordance object includes a visual representation of an object predicted to change in the natural phenomenon according to laws of nature in response to user touch.

9. The display apparatus of claim 1, wherein the change of the natural phenomenon includes one of object separation, growing, blooming, raining and snowing.

10. A method for releasing a lock status of a display apparatus, comprising:
displaying a lock view including an affordance object which represents a changeable natural phenomenon; and
when the affordance object is touched on the lock view, switching to an unlock view while changing the affordance object to represent a change of the natural phenomenon in response to the touch.

11. The method of claim 10, wherein the affordance object is randomly determined every time the lock view is displayed.

12. The method of claim 10, further comprising:
receiving a call connection request;
generating and displaying a plurality of the affordance objects; and
connecting the call when a predetermined affordance object is touched and rejecting the call connection when another predetermined affordance object is touched.

13. The method of claim 12, wherein the plurality of the affordance objects differ in at least one of a shape, a size, and a color.

14. The method of claim 10, wherein the affordance object includes a visual representation of a living object which grows in response to user touch.

15. The method of claim 10, wherein the affordance object includes a visual representation of an object predicted to change in the natural phenomenon according to laws of nature in response to user touch.

16. The method of claim 10, wherein the change of the natural phenomenon includes one of object separation, growing, blooming, raining and snowing.
